(19) United States
(12) Patent Application Publication
(10) Pub. No.: US 2010/0080982 A1
(43) Pub. Date: Apr. 1, 2010

(54) Thermal spray coating application

(75) Inventors: Ondrej Racek, Dunlap, IL (US); M. Brad Beardsley, Laura, IL (US); Mark D. Veliz, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 12/285,309

(22) Filed: Oct. 1, 2008

(51) Int. Cl. B32B 5/00; C23C 4/02; B32B 9/00

(52) U.S. Cl. 428/332; 427/446; 428/411.1

(57) ABSTRACT

A method for coating an element is disclosed. The method includes irradiating a surface of the element with a continuous laser to heat the element. The method also includes coating the surface of the element with a thermal spray coating after irradiating.

### TECHNICAL FIELD

The present disclosure is directed to a thermal spray coating and, more particularly, to surface preparation for bond enhancement of a thermal spray coating.

### BACKGROUND

Several well known high temperature thermal spray methods for coating a substrate exist in the industry today such as, for example, high-velocity oxygen fuel (HVOF) spraying. HVOF is a combustion process in which oxygen is mixed with a fuel gas and ignited, forming an exhaust gas. The exhaust gas is accelerated toward a substrate via a spray torch as metal and/or ceramic material is injected into the gas stream. The injected material becomes molten and is propelled at a high velocity toward the substrate to be coated. One shortcoming of thermal spray methods such as HVOF may be that the bond strength that is achieved between a coating and a substrate may be limited.

U.S. Pat. No. 5,688,564 (the '564 patent) issued to Coddet et al. discloses a process for the preparation of a substrate surface to increase bond strength. The '564 patent discloses irradiating a substrate surface via a pulse laser beam prior to applying a thermal spray coating. The pulse laser beam imparts a large amount of energy into the substrate surface in a very brief amount of time. The pulse laser may improve bond strength of the coating by creating a plasma of vaporized material that expands to cause a shockwave. The shockwave may have a cleaning and roughening effect on the substrate surface that may improve bond strength between the coating and the substrate surface.

Although the process of the '564 patent may provide a method for affecting a shockwave effect to roughen a substrate surface, it may fail to improve the coating bond for metallurgically joining the coating and the substrate. The process described in the '564 patent does not provide a significant increase in thermal energy available at a contact surface between the substrate and the thermal spray particles.

The present disclosure is directed to overcoming one or more of the shortcomings set forth above and/or other deficiencies in the art.

### SUMMARY OF THE DISCLOSURE

In accordance with one aspect, the present disclosure is directed toward a method for coating an element. The method includes irradiating a surface of the element with a continuous laser to heat the element. The method also includes coating the surface of the element with a thermal spray coating after irradiating.

According to another aspect, the present disclosure is directed toward a coating. The coating includes a substrate material and a thermal spray layer. The coating also includes an interface layer bonding the substrate material to the thermal spray layer, the interface layer being greater than about 75% contaminant-free.

### BRIEF DESCRIPTION OF THE DRAWINGS

FIG. 1 is a schematic illustration of an exemplary coating system;

FIG. 2 is a detailed view of the coating system of FIG. 1;

FIG. 3 is a second detailed view of the coating system of FIG. 1; and

FIG. 4 is a flow chart of the coating system of FIG. 1

### DETAILED DESCRIPTION

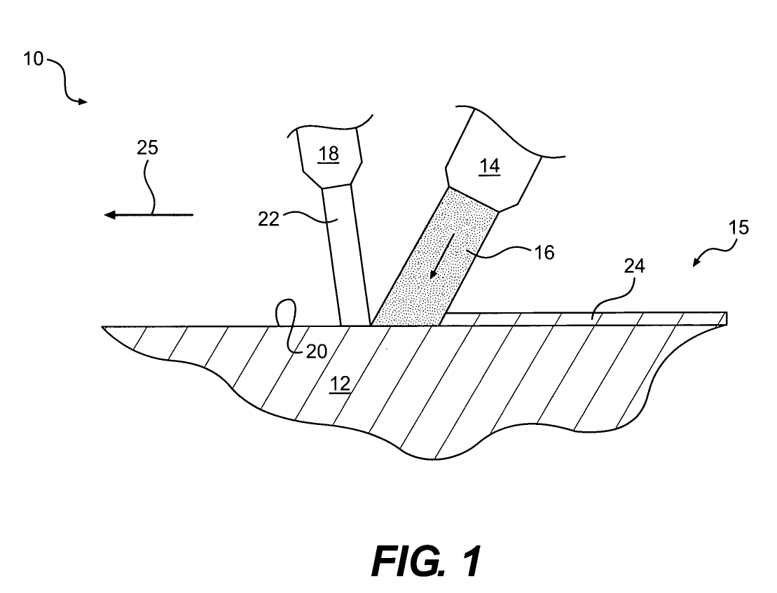

As illustrated in FIG. 1, a coating system 10 may include a depositing device 14, a laser 18, and a coating 15. Depositing device 14 may apply coating 15 to a substrate 12, and laser 18 may improve a bond strength between coating 15 and substrate 12. Coating system 10 may also include an application of flux prior to the process to clean substrate 12 by thermally activating the flux via laser 18.

Depositing device 14 may be any suitable thermal spraying device for depositing a coating material 16 onto substrate 12. Coating material 16 may be deposited onto substrate 12 via any suitable method known in the art such as, for example, combustion wire spraying, combustion powder spraying, twin wire arc spraying, plasma transfer wire arc spraying, wire or powder high-velocity oxygen fuel (HVOF) spraying, or combustion flame spraying. HVOF is a combustion process where oxygen may be mixed with a fuel gas and ignited, forming an exhaust gas stream. The exhaust gas stream may be accelerated toward a substrate at high velocities such as, for example, velocities in excess of about 1400 meter/second (m/s). Coating material 16 may include powder metals or ceramic cermets that are injected generally axially or radially into the exhaust gas stream and become molten as they are propelled toward substrate 12. High velocities of coating material 16 may contribute to mechanical bond strength between coating material 16 and substrate 12. Depositing device 14 may be any suitable application device such as, for example, an HVOF spray gun, a wire arc spray gun, or a plasma arc spray gun. Coating material 16 may be in any suitable form such as, for example, powder, liquid, or wire, and may be introduced into a plasma jet produced by depositing device 14. Depositing device 14 may deposit coating material 16 via any suitable technique such as, for example, a raster motion on flat surfaces or a spiral pattern on rotating elements. Depositing device 14 forms a thermal spray layer 24 on substrate 12.

Laser 18 may be a continuous laser suitable for preparing a surface for a coating such as, for example, a neodymium-doped yttrium aluminium garnet (Nd:YAG) laser, a carbon dioxide laser, or a high power diode laser (HPDL). Laser 18 may be a continuous wave (CW) laser and may operate at a suitable power level for coating such as, for example, of between about 100 and about 2000 W/mm². For example, laser 18 may operate at a power level of between about 500 and about 1500 W/mm². Laser 18 may also operate at a power level of about 400 W/mm². Power level may be determined based on laser spot, which may be a surface area irradiated by laser beam 22. Laser spot may be measured based on the full width at half maximum (FWHM) of the laser power distribution across laser beam 22.

Laser 18 may be mounted on a same fixture as depositing device 14, or alternatively on a different fixture that precedes depositing device 14 in a direction of motion 25 of coating. Laser 18 may be moved in direction of motion 25 at a suitable rate for coating such as, for example, of between about 200 and about 3000 millimeter/second (mm/s) relative to substrate 12. Alternatively, substrate 12 may be moved at a rate of between about 200 and about 3000 mm/s relative to laser 18 and depositing device 14. For example, laser 18 may be moved at a rate of between about 500 and about 1500 mm/s. Depositing device 14 may follow closely behind laser 18 in direction of motion 25, with coating material 16 contacting a surface location at an interval such as, for example, between about 1 and about 20 milliseconds after laser 18 irradiates the surface location.

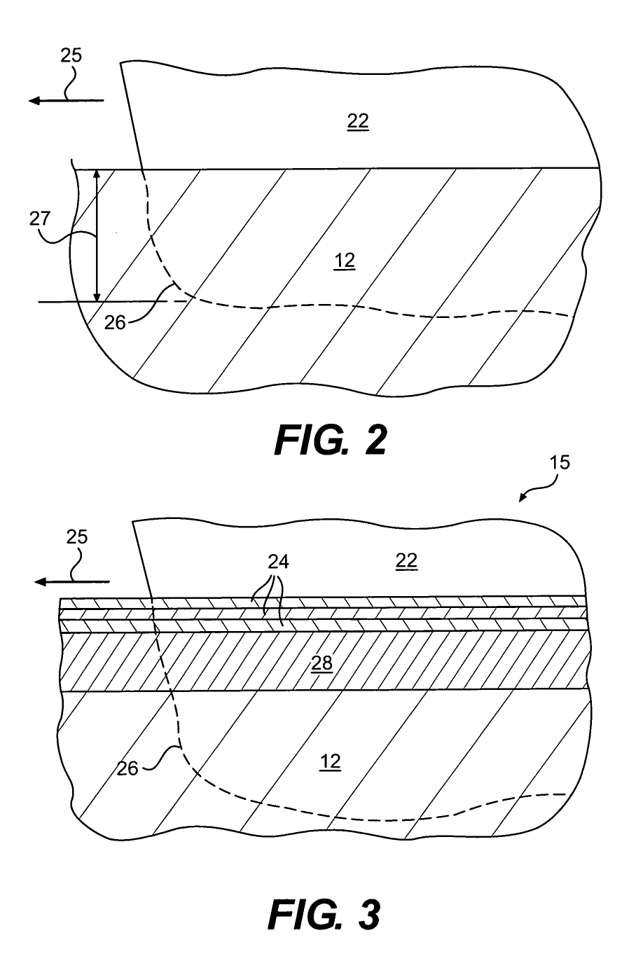

Laser 18 may emit a laser beam 22 that contacts a surface 20 of substrate 12 and/or a previously applied layer 24. As illustrated in FIG. 2, heat from laser beam 22 may produce a laser-affected zone 26 within substrate 12. Laser-affected zone 26 includes portions of substrate 12 and layers 24 having material properties that are changed by laser beam 22. For example, laser-affected zone 26 may include portions of substrate 12 and layers 24 that are heated by laser beam 22. Laser-affected zone 26 has a depth 27 that may result from a combination of parameters such as laser power, laser spot, and traverse speed. Depth 27 may be, for example, between about 100 and about 200 micrometers (μm), and not more than about 500 μm. For example, depth 27 may be between about 125 and about 175 μm. The substrate properties within laser-affected zone 26 such as, for example, hardness may vary based on rapid heating, quenching, and/or tempering. Laser-affected zone 26 is a result of a heat gradient, in which a temperature closer to surface 20 may be higher than a temperature further away from surface 20. Laser beam 22 may heat substrate 12 within laser-affected zone 26, near surface 20, to a maximum temperature such as, for example, of between about 0.7 and about 1.0 of the solidus temperature of substrate 12. Portions of laser-affected zone 26 near surface 20 may be any desired maximum temperature for coating such as, for example, of between about 500° and about 1500° Celsius (C.). For example, laser-affected zone 26 may be between about 800° and about 1200° C. near surface 20.

Depth 27 and the temperature gradient of laser-affected zone 26 may affect bond strength between coating 15 and substrate 12. Although heating substrate 12 may improve bond strength, bond strength may be weakened by too much heat, i.e., by laser-affected zone 26 being too large and/or temperatures being too high. Bond strength may also be weakened by laser-affected zone 26 being too small and/or temperatures being too low. Decreasing a rate of movement of laser 18 may increase the amount of time that laser beam 22 imparts heat into a given location of substrate 12, thereby imparting more heat into substrate 12 than when laser 18 moves at a faster rate. Therefore, controlling the rate of movement of laser 18 may control the amount of heat imparted to substrate 12, and may produce a desired laser-affected zone 26 of an appropriate size and temperature for optimizing bond strength for a given coating material and substrate material. Laser-affected zone 26 may be controlled via laser 18 to avoid melting of substrate 12. Melting may be undesirable because it may significantly reduce a hardness of substrate 12.

As illustrated in FIG. 3, thermal coating 15 may include a plurality of layers 24. Each layer 24 may be applied by a pass of depositing device 14 and laser 18 across substrate 12. Coating 15 may be composed of numerous layers such as, for example, about twenty to thirty layers 24. Each layer 24 may be of any suitable dimensions for coating such as, for example, between about 5 and about 20 μm thick and between about 5 and about 100 mm wide. For example, layer 24 may be between about 10 and about 15 μm thick and between about 40 and about 60 mm wide. As laser 18 makes passes across substrate 12, an interface layer 28 may be produced within laser-affected zone 26. Interface layer 28 is a dilution zone in which substrate 12 and layers 24 are metallurgically bonded. Based on coating system 10, interface layer 28 may be substantially free of contaminants such as, for example, oxide compounds. Interface layer 28 may be about 75% or greater contaminant-free. For example, based on coating system 10, interface layer 28 may be about 90% or greater contaminant-free, about 95% or greater contaminant-free, or about 99% or greater contaminant-free.

Laser beam 22 may affect at least one previously applied layer 24 and a portion of substrate 12 to combine together to form a single interface layer 28 within laser-affected zone 26. After a suitable amount of passes of laser 18 and depositing device 14 such as, for example, about twenty to thirty passes, interface layer 28 may have a thickness of up to about 150 μm. For example, interface layer 28 may be between about 1 and 100 μm thick, or between about 1 and 50 μm thick. Interface layer 28 may have a hardness that is greater than a hardness of substrate 12. Hardness may be measured by a suitable micro-hardness test that measures hardness of a small volume of material such as, for example, a Vickers or Knoop hardness test.

Coating system 10 may include an application of flux to clean surface 20 of substrate 12, and/or surfaces of previously applied layers 24, before irradiation by laser 18. The flux may be any suitable flux known in the art for preventing oxidation such as, for example, fluoride-containing or calcium-containing flux. Oxidation occurs when oxygen molecules interact with molecules of a surface, causing an oxide film to form that may decrease bond strength. Oxidation may occur nearly instantaneously such as, for example, when oxygen molecules contact surface 20. Any suitable method known in the art for applying a thin film of material may be used to apply the flux over an area of surface to be coated such as, for example, via a dispensing device that sprays a thin layer of flux onto a surface. The flux may be inert at relatively low temperatures such as, for example, an ambient outdoor temperature. When subjected to relatively high temperatures such as, for example, laser beam 22, the flux may react with any oxide film that has formed on surface 20 and/or surfaces of layer 24 due to oxidation, to vaporize both the flux and the oxide film. The removal of oxides prior to coating may improve a bond strength between coating 15 and substrate 12.

### INDUSTRIAL APPLICABILITY

Coating system 10 may be used in any coating application. For example, coating system 10 may be used in any manufacturing and remanufacturing applications requiring a thermal spray coating. Laser 18 may improve bond strength by producing a desired laser-affected zone 26 via laser beam 22.

Coating system 10 may be used for new manufacturing of an article, remanufacturing of an article, sealing of an article, and wear resistance applications on an article. Coating system 10 may be used on engine components such as, for example, cylinder heads, cylinder blocks, pistons, piston rings, and crankshafts. Coating system 10 may also be used on track assembly undercarriage components such as, for example, rotatable bushings, idlers, track rollers, track pins, track shoes, track faces, and track links of a chain assembly. For example, coating system 10 may be used for sealing an end face of a bushing. Coating system 10 may be used on implement tool components such as, for example, ripper tips, buckets and bucket edges, blades, ground engaging tools, implement cutting edges, and linkage pins. Coating system 10 may also be used on hydraulic cylinder components such as, for example, rods, rod eyes, rod seals, piston seals, and piston tubes. Coating system 10 may also be used on suspension cylinder components such as, for example, shock-absorbing truck struts.

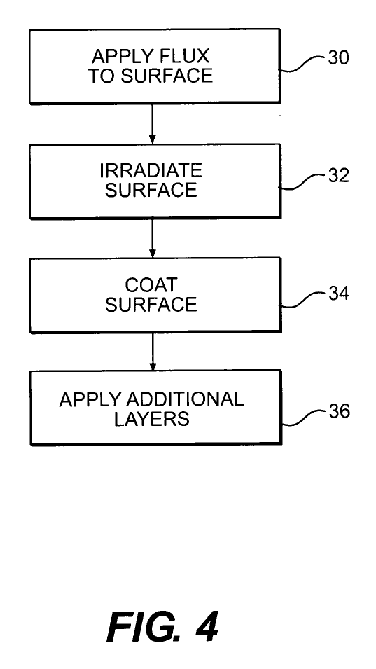

As illustrated in FIG. 4, coating 15 may be applied to substrate 12 according to method steps 30, 32, 34, and 36. In step 30, flux may be applied to surface 20. If coating 15 is being applied as part of a remanufacturing application, an appropriate amount of material may be removed from substrate 12 prior to step 30 such as, for example, about 75 μm or greater of material. In step 32, laser beam 22 may irradiate surface 20, affecting the flux to react with and vaporize any oxides that have formed on surface 20, cleaning and thereby improving characteristics of substrate 12 for bonding with coating 15. Laser beam 22 may also preheat substrate 12 within laser-affected zone 26, the preheating action improving characteristics of substrate 12 for bonding with coating 15. The rate of movement of laser 18 may be controlled to produce a desired laser-affected zone 26 that is appropriate for increasing bond strength between coating 15 and substrate 12. In step 34, depositing device 14 may apply coating material 16 to surface 20. Because depositing device 14 follows closely behind laser 18, as described above, there may not be enough time for an oxide film to be produced on surface 20. In step 36, additional layers 24 may be applied to substrate 12 in a manner similar to steps 30, 32, and 34, in which flux may be applied to a surface of each applied layer 24 to improve bonding of each subsequent layer 24. Iterative passes of laser 18 and depositing device 14 may produce a coating 15 having an interface layer 28 that is substantially oxide-free. Coating 15 may be machined, if required.

Coating system 10 may improve the bond strength between coating 15 and substrate 12. Controlling a rate of movement of laser 18 may produce a desired laser-affected zone 26 of substrate 12, which may improve bond strength. A desired laser-affected zone 26 may be selected, based on material properties of substrate 12 and coating 15, to achieve a desired bond strength. Controlling laser-affected zone 26 may thereby achieve a desired, uniform bond strength. Coating system 10 may also provide a relatively small interface layer 28 having metallurgical properties that may improve bonding between coating 15 and substrate 12. Metallurgical properties of interface layer 28 may also reduce the probability of feathering (i.e., removing coating and exposing uncoated substrate material) during machining after applying coating 15. Laser 18 may also clean a surface to be coated, which may improve bond strength of coating 15 and may eliminate the need for grit-blasting the surface.

It will be apparent to those skilled in the art that various modifications and variations can be made to the disclosed coating system. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A method for coating an element, comprising:
irradiating a surface of the element with a continuous laser to heat the element; and
coating the surface of the element with a thermal spray coating after irradiating.

2. The method of claim 1, wherein coating the surface occurs between about 1 and about 20 milliseconds after irradiating the surface.

3. The method of claim 1, wherein a rate of movement between the continuous laser and the surface of the element is between about 200 and about 3000 mm/s relative to a substrate.

4. The method of claim 1, wherein the continuous laser operates at a power level of between about 100 and about 2000 W/mm².

5. The method of claim 4, wherein the continuous laser operates at a power level of about 400 W/mm².

6. A method for coating an element, comprising:
irradiating a surface of the element with a laser;
controlling a rate of movement of the laser to produce a desired laser-affected zone of the element; and
coating the surface of the element with a thermal spray coating after irradiating.

7. The method of claim 6, wherein a depth of the laser-affected zone is not more than about 500 μm.

8. The method of claim 6, wherein a depth of the laser-affected zone is between about 100 and about 200 μm.

9. The method of claim 6, wherein a maximum temperature of the laser-affected zone is between about 0.7 and about 1.0 of the solidus temperature of the element.

10. The method of claim 6, wherein a maximum temperature of the laser-affected zone is between about 500° and about 1500° C.

11. An article, comprising:
a substrate material;
a thermal spray layer; and
an interface layer bonding the substrate material to the thermal spray layer, the interface layer being about 75% or greater contaminant-free.

12. The article of claim 11, wherein the interface layer is about 90% or greater contaminant-free.

13. The article of claim 11, wherein the interface layer is about 95% or greater contaminant-free.

14. The article of claim 11, wherein the interface layer has a hardness that is greater than a substrate material hardness.

15. The article of claim 11, wherein the interface layer is between about 1 μm and about 150 μm thick.

16. The article of claim 11, wherein the article is a cylinder head, cylinder block, or crankshaft of an engine.

17. The article of claim 11, wherein the article is a piston or a piston ring of an engine.

18. The article of claim 11, wherein the article is a track assembly undercarriage component.

19. The article of claim 11, wherein the article is an implement tool component.

20. The article of claim 11, wherein the article is a hydraulic cylinder component or a suspension cylinder component.
